(19) United States
(12) Patent Application Publication
(10) Pub. No.: US 2026/0257512 A1
(43) Pub. Date: Sep. 3, 2026

(54) ENGRAVING TOOL, CARRIAGE FOR ENGRAVING TOOL, AND ENGRAVING MACHINE

(71) Applicant: Huansheng Intelligent (Shenzhen) Co., Ltd., Shenzhen (CN)

(72) Inventors: Mingliang GAO, Shenzhen (CN); Jiandu HE, Shenzhen (CN); Guangping HU, Shenzhen (CN); Xingjin LIAO, Shenzhen (CN); Tian MEI, Shenzhen (CN)

(21) Appl. No.: 19/658,745

(22) Filed: Apr. 27, 2026

(30) Foreign Application Priority Data
Jan. 20, 2026 (CN) 202620072267.X
Jan. 20, 2026 (CN) 2026200744698

(51) Int. Cl. B44B 3/06; B44B 3/00

(52) U.S. Cl. CPC B44B 3/061; B44B 3/005

(57) ABSTRACT

An engraving tool including: a housing, and a terminal piece is disposed in the housing; a driving motor having one end connected to the terminal piece; and a cutting tool assembly connected to a driving end of the driving motor; the terminal piece is configured to connect with an external power supply, and the driving motor is configured to drive the cutting tool assembly to perform telescopic movement in an axial direction. The engraving tool is directly supplied by an external power source, thereby enhancing the power supply stability and adaptability. The drive motor directly drives the tool assembly to extend and retract axially, allowing for adjustment of the cutting tool assembly's extension length. This eliminates the inconvenience associated with traditional engraving tools that rely on manual adjustment or fixed extension structures, as well as the issues of unstable engraving depth, thereby facilitating improved engraving accuracy.

### CROSS REFERENCE TO RELATED APPLICATIONS

This application claims foreign priority of Chinese Patent Application No. 202620072267.X, filed on Jan. 20, 2026 and No. 202620074469.8, filed on Jan. 20, 2026 in the China National Intellectual Property Administration, the disclosures of all of which are hereby incorporated by reference.

### TECHNICAL FIELD

The present disclosure relates to the technical field of engraving equipment technology, in particular to an engraving tool, a carriage for an engraving tool, and an engraving machine.

### BACKGROUND

In conventional engraving equipment, the cutter is typically adjusted manually for its protrusion length or is fixed in position through structural limits to achieve engraving operations. Such structures require the operator to set the cutter protrusion based on experience before use. Once set, the cutter position remains relatively unchanged during engraving, lacking dynamic adjustment capability for the engraving status.

However, in actual engraving processing, the workpiece surface often has thickness variations, local unevenness, or clamping height errors, especially in batch processing or automated engraving scenarios, where dimensional deviations and clamping errors between different workpieces are more prominent. Since the protrusion length of traditional cutters cannot be adjusted in real-time according to working conditions, when the workpiece surface height changes, the actual contact depth between the cutter and the workpiece may deviate, resulting in inconsistent engraving depths. This can lead to overly deep or shallow marks, or even incomplete engraving in certain areas.

Additionally, manually adjusting the cutter protrusion depends on the operator's judgment, which is not only a cumbersome process but also lacks repeatability. When the equipment frequently switches between different working conditions, repeated downtime is needed to adjust the cutter's position, reducing production efficiency. At the same time, since the adjustment precision is difficult to control, cumulative errors can accumulate during engraving, further amplifying fluctuations in engraving quality. When the engraving depth cannot be maintained consistently, it not only affects the appearance quality of the engraving but also may accelerate tool wear due to excessive localized force, shortening the tool's service life and affecting the overall machining accuracy of the engraving equipment.

### SUMMARY

The main objective of the present disclosure is to provide a carriage for an engraving tool, which helps improve engraving quality and precision.

To realize the above objective, the present disclosure provides an engraving tool including: a housing, a terminal piece is disposed in the housing; a driving motor having one end connected to the terminal piece; and a cutting tool assembly connected to a driving end of the driving motor; the terminal piece is configured to connect with an external power supply, and the driving motor is configured to drive the cutting tool assembly to perform telescopic movement in an axial direction.

Furthermore, the driving motor is connected to a sensor configured to detect a rotational speed of the cutting tool assembly.

Furthermore, an output end of the driving motor is connected to a reducer, and an output end of the reducer is connected to the cutting tool assembly for driving the cutting tool assembly to move in the axial direction.

Furthermore, the cutting tool assembly includes a connecting rod and a cutter head; one end of the connecting rod is connected to the reducer, and the other end of the connecting rod is connected to the cutter head, so as to drive the cutter head to telescopically move in the axial direction.

Furthermore, the cutting tool assembly further includes an elastic component disposed between the connecting rod and the housing, wherein the elastic component is configured to apply an axial elastic force to the connecting rod.

Furthermore, an annular groove is disposed in the housing, and the cutting tool assembly is provided with a protruding ring matched with the annular groove, for limiting an axial movement direction of the cutting tool assembly.

The present disclosure further provides a carriage for an engraving tool, including a mounting body, a driving assembly, and the engraving tool mentioned above, the engraving tool is connected to the mounting body through a mounting column, and two ends of the mounting column are respectively connected to the driving assembly and the engraving tool; a driving end of the driving assembly is connected to the mounting column and is configured to drive the mounting column to reciprocate in a vertical direction, so as to drive the engraving tool to move downwardly or move upwardly in the vertical direction.

Furthermore, the mounting body is provided with a cutter-adjusting assembly, one side of the mounting column away from the engraving tool is provided with an adjusting column, and the cutter-adjusting assembly is clamped on the adjusting column.

Furthermore, the cutter-adjusting assembly includes a mounting plate, a first clamping column, and a second clamping column; the mounting plate is detachably connected to the mounting body, the first clamping column and the second clamping column are both connected to the mounting plate; and a spacing is formed between the first clamping column and the second clamping column for the adjusting column to pass through.

Furthermore, the driving assembly includes an electromagnetic driving component, a push rod, and a transmission component; an output end of the electromagnetic driving component is connected to the push rod; and two ends of the transmission component are respectively connected to the push rod and the mounting column; and the electromagnetic driving component is configured to drive the push rod to perform reciprocating linear motion in the vertical direction, and the transmission component is configured to transmit linear motion of the push rod to the mounting column, such that the engraving tool moves in the vertical direction.

Furthermore, further including a protective cover and a flip cover; the flip cover is hinged to the protective cover, and the flip cover and the protective cover jointly define an accommodating space for accommodating the mounting body and the engraving tool.

The present disclosure further provides an engraving machine, including the carriage for the engraving tool mentioned above, the carriage for the engraving tool is mounted on the engraving machine and is slidably connected to the engraving machine.

Furthermore, the engraving machine including a sliding rail and a pulley; the sliding rail is mounted on the engraving machine and is connected to the mounting body; and the pulley is slidably connected to the sliding rail, such that the carriage for the engraving tool reciprocatingly slides along a length direction of the engraving machine.

The engraving tool includes: a housing, with a terminal piece arranged inside the housing; a driving motor having one end connected to the terminal piece; and a cutting tool assembly, connected to the drive end of the driving motor. The terminal piece is configured to connect with an external power supply, and the driving motor is configured to drive the engraving tool assembly to perform a telescopic movement in an axial direction. By providing a terminal piece within the housing and electrically connecting the driving motor to the terminal piece, the engraving tool can be directly powered by an external power supply, thus improving the stability and compatibility of the overall power supply. Meanwhile, by directly driving the engraving tool along the axial direction with the driving motor, the protrusion length of the cutter can be adjusted, avoiding the operational inconvenience and instability of engraving depth caused by relying on manual adjustments or fixed protrusion structures. This reduces engraving quality fluctuations caused by workpiece surface unevenness or operational errors, thereby improving engraving precision.

### BRIEF DESCRIPTION OF THE DRAWINGS

FIG. 1 is a schematic structural diagram showing an engraving tool according to an embodiment of the present disclosure.

FIG. 2 is an exploded view of the engraving tool according to an embodiment of the present disclosure.

FIG. 3 is a schematic structural diagram of a housing and a cutting tool assembly of the engraving tool according to an embodiment of the present disclosure.

FIG. 4 is a cross-sectional view of the engraving tool according to an embodiment of the present disclosure.

FIG. 5 is a schematic structural diagram of an engraving machine according to an embodiment of the present disclosure.

FIG. 6 is a schematic structural diagram of part of the structure of the carriage for the engraving tool according to an embodiment of the present disclosure.

FIG. 7 is a schematic structural diagram of part of a carriage for the engraving tool according to an embodiment of the present disclosure.

FIG. 8 is a schematic structural diagram of a part of the carriage for the engraving tool according to an embodiment of the present disclosure.

FIG. 9 is a schematic structural diagram of a part of the carriage for the engraving tool according to an embodiment of the present disclosure.

### DESCRIPTION OF THE REFERENCE NUMERALS

100, mounting body; 110, mounting column;
200, engraving tool; 210, housing; 220, terminal piece; 230, annular groove; 240, driving motor; 250, cutting tool assembly; 251, connecting rod; 252, cutter head; 253, protruding ring; 254, elastic component; 260, sensor; 270, reducer;
300, driving assembly; 310, electromagnetic driving component; 320, push rod; 330, transmission component;
400, cutter-adjusting assembly; 410, mounting plate; 420, first clamping column; 430, second clamping pillar;
500, adjusting column;
600, protective cover;
700, flip cover;
800, engraving machine; 810, sliding rail; 820, pulley; 830, engraving machine body;
1000, carriage for engraving tool.

The implementation, functional features, and advantages of the present disclosure will be further described in conjunction with the embodiments and the attached drawings.

### DETAILED DESCRIPTION OF THE EMBODIMENTS

It should be understood that the specific embodiments described here are intended to explain the present disclosure, and are not intended to limit the application.

In the description of the present disclosure, it is to be understood that terms such as “center,” “longitudinal,” “lateral,” “length,” “width,” “thickness,” “up,” “down,” “front,” “rear,” “left,” “right,” “vertical,” “horizontal,” “top,” “bottom,” “inner,” “outer,” “clockwise,” “counterclockwise,” etc., indicating directional or positional relationships, are based on the orientations or positional relationships shown in the drawings for ease of description and simplification, and are not intended to indicate or imply that the devices or components described must have specific orientations or be constructed or operated in specific orientations. Therefore, these terms should not be understood as limiting the present disclosure. In addition, terms such as “first” and “second” are used only for descriptive purposes and should not be understood as indicating or implying relative importance or implicitly indicating the number of features specified. As such, features designated as “first” or “second” can explicitly or implicitly include one or more such features. In the present description, “multiple” refers to two or more, unless otherwise specifically defined.

In the present disclosure, it should be noted that unless otherwise specified, terms like “installed,” “connected,” and “coupled” should be understood broadly, such as fixed or removable connections, mechanical connections, or direct or indirect connections through intermediaries. For ordinary skilled persons in the field, the specific meaning of these terms in the context of this application can be understood according to the specific circumstances.

In the present disclosure, unless otherwise specified, the feature “above” or “below” a second feature may include direct contact between the first and second features or may involve them being separated by other features. Furthermore, “above,” “above side,” and “on top” include the first feature being directly above or at an angle to the second feature, or simply indicating that the first feature is at a higher horizontal level than the second feature. Similarly, “below,” “below side,” and “beneath” include the first feature being directly below or at an angle to the second feature, or simply indicating that the first feature is at a lower horizontal level than the second feature.

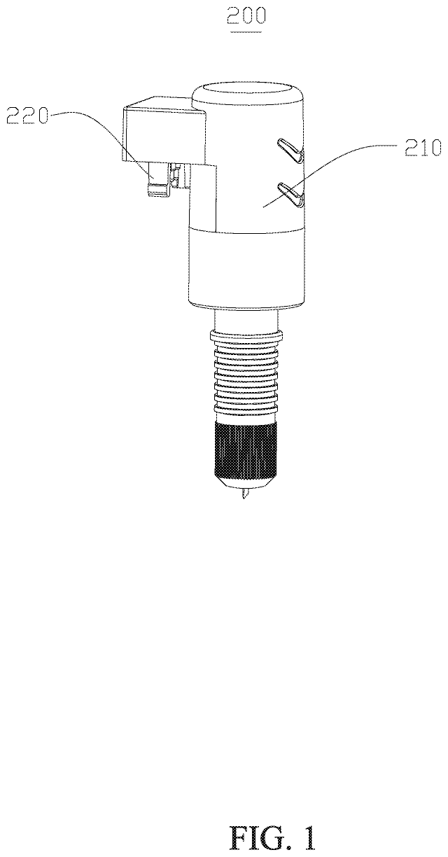

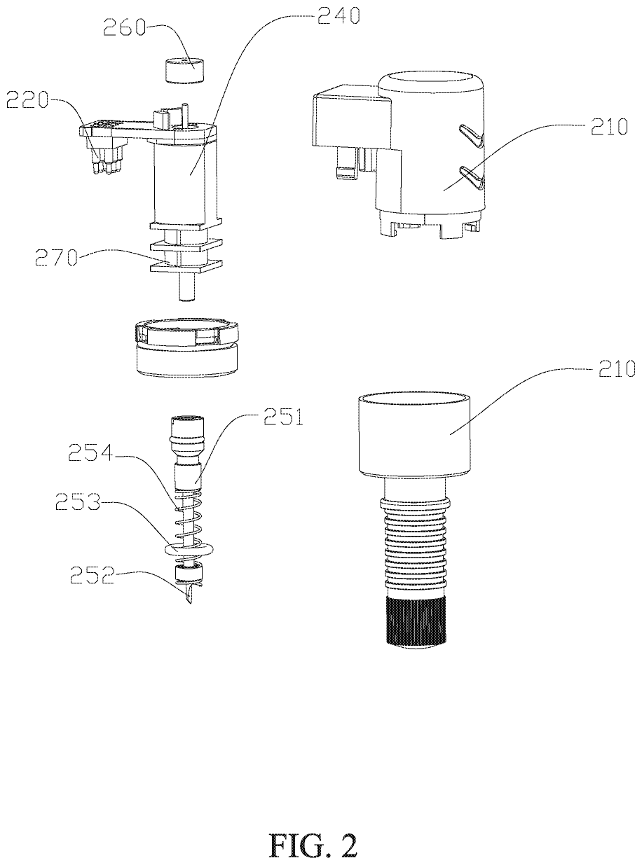

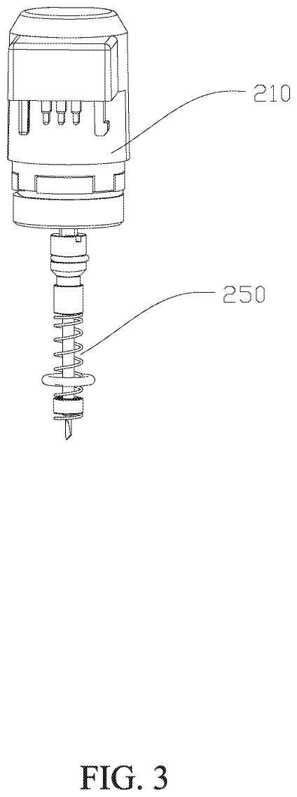

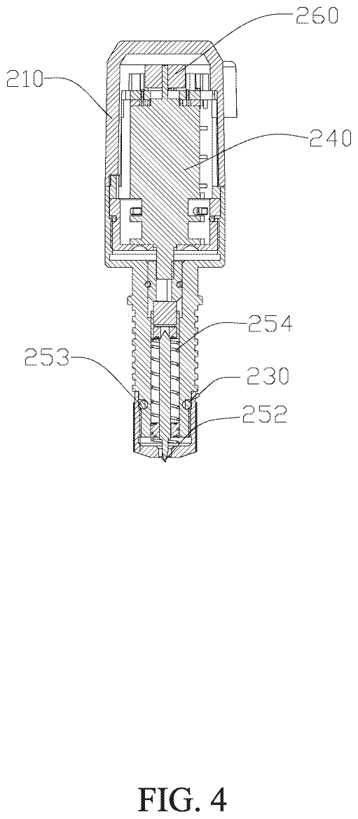

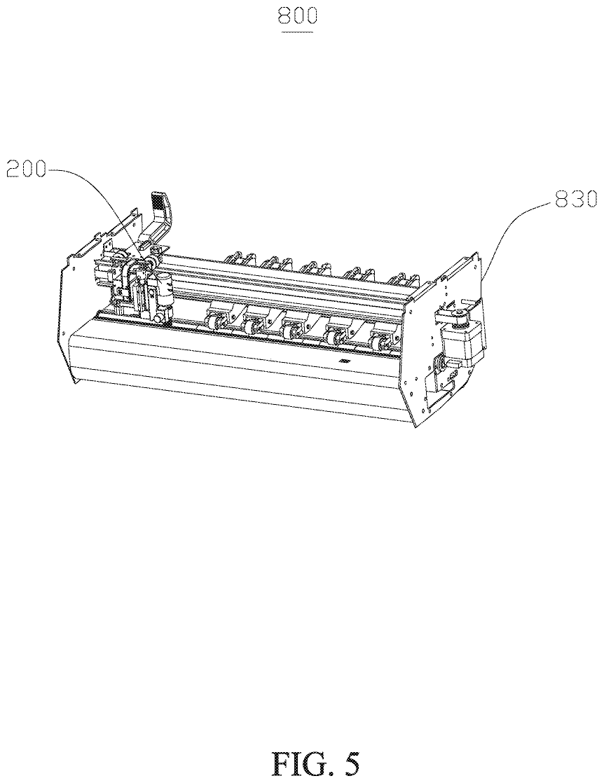

With reference to FIGS. 1 to 5, the present disclosure provides an engraving tool 200. The engraving tool 200 includes a housing 210, a driving motor 240, and a cutting tool assembly 250. A terminal piece 220 is disposed within the housing 210. One end of the driving motor 240 is connected to the terminal piece 220. The cutting tool assembly 250 is connected to a driving end of the driving motor 240. The terminal piece 220 is configured to be externally connected to a power supply, and the driving motor 240 is configured to drive the cutting tool assembly 250 to perform telescopic movement in an axial direction.

In engraving processing equipment, as an execution component directly acting on the surface of a workpiece, the movement mode and adjustment mode of the engraving tool directly affect the stability of engraving depth, processing consistency, and automation adaptation capability. In existing engraving tools, the extension length of the engraving tool is usually realized by means of manual knob adjustment, spacer limiting, or fixed installation. Although such structures can satisfy basic use requirements in a single processing operation, in an automatic engraving machine 800 or a continuous processing scenario, it is difficult to dynamically adjust the position of the engraving tool according to different working conditions, and uneven engraving depths are likely to be caused due to differences in workpiece thickness, clamping errors, or surface undulations, and even a problem of abnormal tool wear may occur.

Based on the above background, by arranging the terminal piece 220 inside the housing 210 and connecting the driving motor 240 to the terminal piece 220, direct docking of the engraving tool with an external power supply system of the engraving machine 800 is achieved. Further, the driving motor 240 is utilized to directly drive the cutting tool assembly 250 to perform telescopic movement in the axial direction, such that the extension length of the cutting tool assembly 250 no longer depends on manual adjustment, but is converted into a mechanical movement controllable by a driving component.

When the engraving machine 800 is operating, the driving motor 240 is activated by a control signal, with its driving end connected to the cutting tool assembly 250. The output motion of the driving motor 240 is converted by a transmission structure inside the housing 210 from rotational to linear motion, thereby driving the cutting tool assembly 250 to be displaced along the axial direction. So that the cutting tool assembly 250 extends out of or retracts relative to the housing 210. Under different working instructions, the driving motor 240 can drive the cutting tool assembly 250 to perform controllable reciprocating movement in the axial direction, such that the actual extension length of the cutting tool assembly 250 is changed accordingly, thereby corresponding to requirements of different engraving working conditions. During the engraving process, the cutting tool assembly 250 contacts the surface of the workpiece in a state in which the axial position is controlled, and completes an engraving operation. When it is necessary to adjust the engraving depth or enter or exit a processing state, the driving motor 240 acts again, and the axial position of the cutting tool assembly 250 is changed through the transmission structure, so that the cutting tool assembly 250 is separated from the workpiece or repositioned to a predetermined working position. Throughout the entire process, the axial movement of the cutting tool assembly 250 is actively completed by the driving motor 240, the movement process is continuous and controllable, no manual intervention is required, and no complex passive adjustment structure is relied upon. By introducing, into the engraving tool structure, axial telescopic movement of the tool directly controlled by the driving motor 240, the extension length of the cutting tool assembly 250 can be actively adjusted, thereby solving the problem that the engraving depth is uncontrollable due to reliance on manual adjustment or fixed limiting in the conventional engraving tool structure. In the application scenario of the engraving machine 800, this is beneficial to improving consistency of engraving effects during batch processing. Meanwhile, since the axial movement of the cutting tool assembly 250 is completed by the driving motor 240, when the engraving tool enters and exits an engraving state, implementation by means of mechanical collision or passive rebound is no longer required, and smooth transition can be achieved before and after engraving, thereby reducing an impact risk between the cutting tool assembly 250 and the workpiece, reducing abnormal tool wear, and improving service life of the cutting tool assembly 250.

The driving motor 240 is connected to a sensor 260 configured to detect a rotational speed of the cutting tool assembly 250.

An output end of the driving motor 240 is connected to a reducer 270, and an output end of the reducer 270 is connected to the cutting tool assembly 250 and is configured to drive the cutting tool assembly 250 to move in the axial direction.

During the engraving process, the cutting tool assembly 250 not only needs to have the capability of controllable axial positioning, but also the motion state thereof directly affects engraving quality and stability of equipment operation. If an output state of the driving motor 240 under different load conditions cannot be sensed or fed back, situations such as rotational speed fluctuation, sudden load variation, or abnormal jamming are likely to occur during the engraving process, thereby affecting consistency of engraving depth and even causing tool damage.

In view of this, in the present embodiment, by arranging the sensor 260 on the driving motor 240, a rotation state related to the cutting tool assembly 250 is detected in real time, such that the motion state of the cutting tool assembly 250 during the engraving process is changed from “imperceptible” to “monitorable”. Secondly, by arranging the reducer 270 between the driving motor 240 and the cutting tool assembly 250, the output movement of the driving motor 240 is subjected to reasonable speed and torque matching before being transmitted to the cutting tool assembly 250, thereby providing a more stable and controllable driving force source for the axial movement of the cutting tool assembly 250.

During operation of the equipment, when the driving motor 240 is started under the action of a control signal, the output end thereof first performs power transmission through the reducer 270. The reducer 270 reduces an output rotational speed of the driving motor 240 and correspondingly increases output torque, such that a rotational output of the driving motor 240 is more suitable for subsequent execution of an axial driving action. The speed-reduced output movement is transmitted from the output end of the reducer 270 to the cutting tool assembly 250, such that the cutting tool assembly 250 is displaced along the axial direction of the engraving tool under the action of the driving force, thereby completing extension or retraction of the cutting tool assembly 250. Meanwhile, the sensor 260 arranged on the driving motor 240 detects, in real time, the driving motor 240 or a rotating component associated with the cutting tool assembly 250, and feeds back detected rotational speed information to a control system of the engraving machine 800. The control system can monitor or adjust an operating state of the driving motor 240 according to the obtained rotational speed data, thereby ensuring that the cutting tool assembly 250 is always in an expected motion state during axial movement and the engraving process.

During the engraving operation, when the cutting tool assembly 250 contacts the workpiece and performs engraving, the driving motor 240 outputs a stable driving force in cooperation with the reducer 270, thereby ensuring that the axial position variation of the cutting tool assembly 250 is smooth and controllable. When operating conditions change or the engraving stage transitions, the sensor 260 continuously provides rotational speed information, enabling the control system to promptly detect changes in motion state and to avoid engraving depth fluctuations or mechanical shocks caused by abnormal rotational speed. Through the collaborative action of the sensor 260 and the reducer 270, the axial movement process of the cutting tool assembly 250 remains continuous throughout the entire engraving cycle.

The cutting tool assembly 250 includes a connecting rod 251 and a cutter head 252. One end of the connecting rod 251 is connected to the reducer 270, and the other end of the connecting rod 251 is connected to the cutter head 252, thereby driving the cutter head 252 to extend or retract along the axial direction.

The cutting tool assembly 250 further includes an elastic component 254, which is disposed between the connecting rod 251 and the housing 210 to apply an axial elastic force to the connecting rod 251.

The housing 210 is provided with an annular groove 230, and the cutting tool assembly 250 is provided with a protruding ring 253 that cooperates with the annular groove 230, for limiting the axial direction of the cutting tool assembly 250.

In the present embodiment, the cutting tool assembly 250 includes the connecting rod 251, the cutter head 252, the elastic component 254, and the protruding ring 253 for axial limiting. The connecting rod 251 is arranged along the axial direction of the engraving tool, one end is connected to the output end of the reducer 270 and the other end connected to the cutter head 252, so as to drive the cutter head 252 to extend or retract along the axial direction under the action of the driving motor 240. The connecting rod 251 serves as an intermediate transmission component of the cutting tool assembly 250, transmitting the driving force output from the driving motor 240 through the reducer 270 to the cutter head 252, thereby achieving axial position adjustment of the cutter head 252 is achieved.

The elastic component 254 is disposed between the connecting rod 251 and the housing 210 along the axial direction of the connecting rod 251, for applying an axial elastic force to the connecting rod 251. When the connecting rod 251 moves toward the engraving direction under the driving force, the elastic component 254 is compressed and stores elastic potential energy. When the driving force decreases or reverses, the elastic component 254 releases the stored elastic potential energy, generating a restoring or buffering effect on the connecting rod 251, thereby making the axial movement process of the connecting rod 251 and the cutter head 252 smoother and more continuous. By providing the elastic component 254, instantaneous impacts during the movement of the connecting rod 251 and the cutter head 252 can be absorbed, improving the force conditions when the cutter head 252 contacts the workpiece.

The housing 210 is provided with an annular groove 230, and the outer side of the cutting tool assembly 250 is provided with a protruding ring 253 that cooperates with the annular groove 230 to limit the axial movement direction of the cutting tool assembly 250. In the present embodiment, the protruding ring 253 is a spring ring structure, the spring ring abutting the inner wall of the annular groove 230 and maintaining engagement with the inner wall through its radial elasticity. By cooperating the spring ring with the annular groove 230, the cutting tool assembly 250 is circumferentially enclosed and constrained in the axial direction, thereby preventing deviation, tilting, or exceeding the preset stroke. During the axial extension and retraction of the cutter head 252, the spring ring can undergo slight elastic deformation within the annular groove 230 to compensate for assembly errors or instantaneous impacts generated during movement, transforming the limiting process from rigid constraint to a controlled constraint with certain flexibility. The spring-ring type limiting structure ensures the stability of the axial movement of the cutting tool assembly 250, reduces friction resistance and structural noise, and compensates for clearance changes caused by wear during long-term operation.

Through the cooperative arrangement of the connecting rod 251, the elastic component 254, and the spring-ring limiting structure, the cutting tool assembly 250 can stably and controllably perform axial extension and retraction under the action of the driving motor 240, while simultaneously ensuring transmission stability, buffering performance, and movement limiting requirements, thereby guaranteeing the positional accuracy of the cutter head 252 during the operation of the engraving machine 800.

In the present embodiment, an engraving machine 800 is provided, which applies the engraving tool 200 of any of the aforementioned embodiments. The engraving machine 800 includes a body 830 and the engraving tool 200 slidably mounted on the engraving machine body 830. The engraving machine body 830 of the engraving machine 800 provides an installation base and motion support for engraving operations. The engraving tool 200 serves as an execution unit of the engraving machine 800, capable of sliding relative to the engraving machine body 830 within the working region of the engraving machine 800 to perform engraving operations.

During operation, the engraving machine body 830 fixes the workpiece to be engraved within a predetermined processing region. The engraving tool 200 moves along the sliding direction on the engraving machine body 830 under the control system's instruction, gradually approaching the workpiece surface. When the engraving tool 200 reaches the target engraving position, the driving motor 240 within the engraving tool 200 is activated to drive the cutting tool assembly 250 to extend along the axial direction of the engraving tool 200, so that the cutter head 252 protrudes from its initial position and contacts the workpiece surface.

During engraving, the engraving tool 200 completes planar sliding movement under the guidance of the engraving machine body 830, while the axial extension and retraction of the cutting tool assembly 250 adjusts the engraving depth. The engraving tool 200 performs engraving along a predetermined trajectory on the workpiece surface with controlled axial position, so that the engraving depth and path can be executed stably according to preset parameters. By combining the axial extension and retraction of the engraving tool 200 with its sliding motion on the body 830, continuous and consistent engraving operations are achieved.

When the engraving operation is completed or the predetermined processing region needs to be switched, the engraving tool 200 continues to slide to the next engraving position under the drive of the body 830, or the cutting tool assembly 250 retracts axially under the control of the driving motor 240, causing the cutter head 252 to disengage from the workpiece surface and enter a non-processing state. After the engraving tool 200 exits the engraving state, the body 830 can replace the workpiece or proceed to the next engraving cycle. By the above structural design, the engraving machine 800 coordinates the axial extension and retraction of the engraving tool 200 with the sliding motion provided by the body 830, ensuring coordinated positional changes of the cutter head 252 and movement along the engraving path. The engraving machine 800 can achieve controllable adjustment of engraving depth without manual adjustment of tool extension length, improving the stability and repeatability of engraving operations, suitable for automated or continuous engraving scenarios.

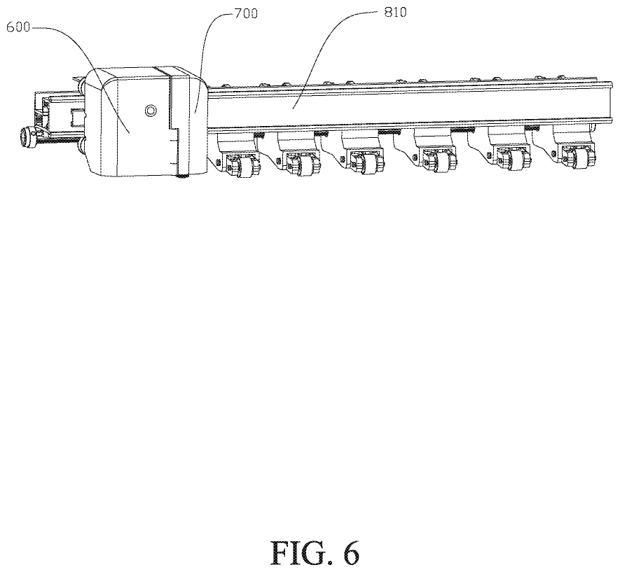

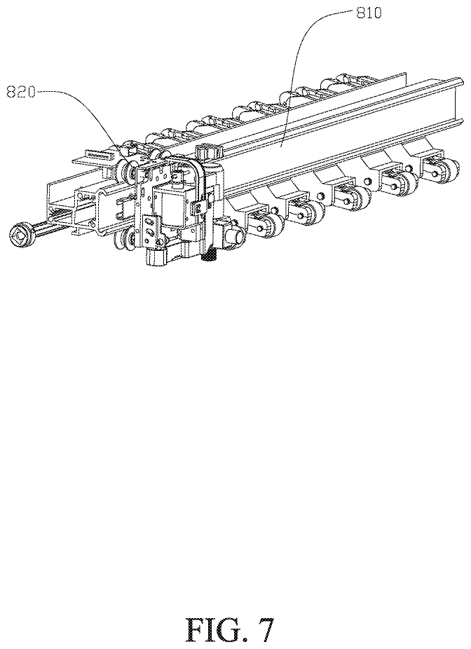

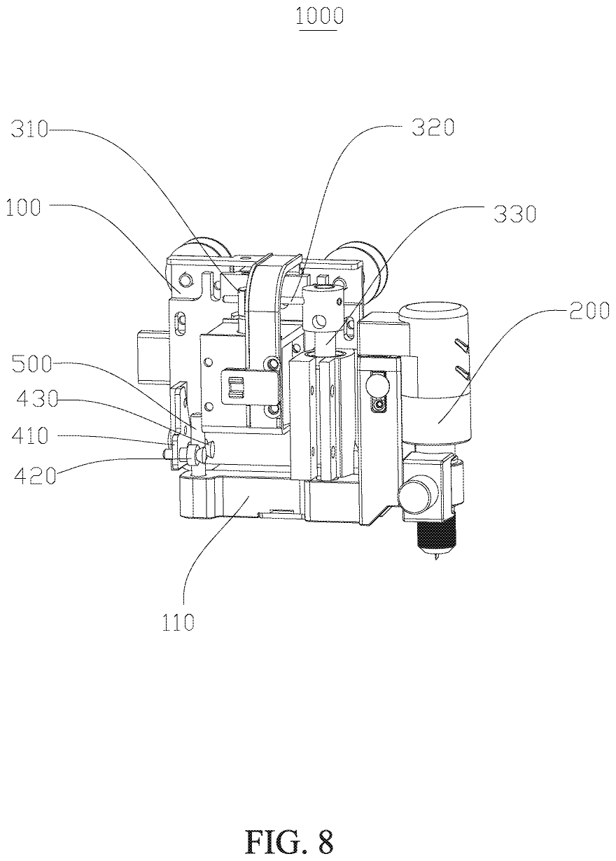

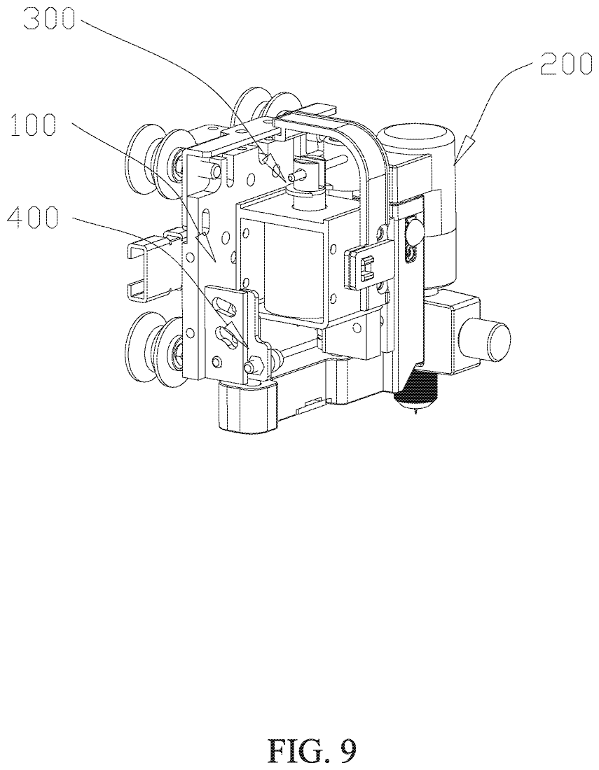

Referring to FIGS. 6 to 9, this disclosure provides a carriage for the engraving tool 1000, including a mounting body 100 and the engraving tool 200 and driving assembly 300 mounted thereon. The engraving tool 200 is connected to the mounting body 100 via a mounting column 110, the two ends of which are respectively connected to the driving assembly 300 and the engraving tool 200.

The driving end of the driving assembly 300 is connected to the mounting column 110 and is configured to drive the mounting column 110 to reciprocate in the vertical direction, thereby driving the engraving tool 200 to move downward or be raised in the vertical direction.

In this embodiment, both the engraving tool 200 and the driving assembly 300 are mounted on the mounting body 100. The engraving tool 200 is connected to the mounting body 100 via the mounting column 110, allowing the engraving tool 200 to have the freedom to move in the vertical direction relative to the mounting body 100. The driving assembly 300 is located on the mounting body 100, with its driving end connected to the mounting column 110. When the equipment operates, the carriage for the engraving tool 1000 moves along a planar trajectory guided by the engraving machine 800. Upon reaching the designated engraving position, the control system sends a command to the driving assembly 300. The driving end of the driving assembly 300 moves reciprocally in the vertical direction under the action of a control signal, and this movement is transmitted directly to the engraving tool 200 through the mounting column 110, causing the engraving tool 200 to produce a downward or upward displacement relative to the mounting body 100. When the mounting column 110 moves downward, the engraving tool 200 moves downward, contacting the workpiece surface and completing the engraving or cutting operation. When the drive component 300 acts in reverse, the mounting column 110 drives the engraving tool assembly 200 to return to its original position, causing the cutter to disengage from the workpiece surface and enter the next movement trajectory. This arrangement is beneficial in improving the response speed and repeatability of the cutting action. Under high-speed engraving or frequent start-stop conditions, the engraving tool 200 can stably and controllably perform downward and upward movements, helping to ensure engraving depth and cutting precision.

The mounting body 100 is provided with a cutter-adjusting assembly 400, and an adjusting column 500 is arranged on the side of the mounting column 110, on the side opposite to the engraving tool 200. The cutter-adjusting assembly 400 is clamped to the adjusting column 500.

The cutter-adjusting assembly 400 includes a mounting plate 410, a first clamping column 420, and a second clamping column 430. The mounting plate 410 is detachably connected to the mounting body 100. The first clamping column 420 and the second clamping column 430 are both connected to the mounting plate 410, with a spacing formed between them for the adjusting column 500 to pass through.

The cutter-adjusting assembly 400 is set on the mounting body 100, with the adjusting column 500 arranged on the side of the mounting column 110, on the side opposite to the engraving tool 200. The cutter-adjusting assembly 400 includes the mounting plate 410, the first clamping column 420, and the second clamping column 430. The mounting plate 410 is detachably connected to the mounting body 100, and the first clamping column 420 and second clamping column 430 are fixed to the mounting plate 410, with spacing between them to allow the adjusting column 500 to pass through. During tool adjustment, the adjusting column 500 is positioned between the first clamping column 420 and second clamping column 430. The cutter-adjusting assembly 400 clamps and locates the adjusting column 500. During tool setup, after the engraving tool 200 is installed, the cutter-adjusting assembly 400 clamps and locates the adjusting column 500. Since the adjusting column 500 and mounting column 110 are part of the same structural chain, after the adjusting column 500 is clamped, slight misalignment and assembly deviation in the corresponding direction of the mounting column 110 are suppressed, “locking” the engraving tool 200 at a reproducible position in the reference state. For subsequent tool changes or reinstallation, the mounting plate 410 can be detached, allowing the cutter-adjusting assembly 400 to be restored consistently, reducing the need for repeated trial engravings and calibration. By setting up the cutter-adjusting assembly 400 on the mounting body 100 and using the first clamping column 420 and second clamping column 430 to clamp and locate the adjusting column 500, the reference position of the engraving tool 200 after installation becomes more stable, effectively reducing the cutter position drift caused by tool length differences, clamping tightness differences, and repeated disassembly and reinstallation. This helps achieve a more consistent cutter tip reference during engraving, making the starting position more controllable and enabling cleaner engraving along precision-sensitive paths such as fine lines and corners. As a result, the consistency of the engraving is improved.

The driving assembly 300 includes an electromagnetic driving component 310, a push rod 320, and a transmission component 330. The output end of the electromagnetic driving component 310 is connected to the push rod 320. The two ends of the transmission component 330 are respectively connected to the push rod 320 and the mounting column 110. The electromagnetic driving component 310 is configured to drive the push rod 320 to reciprocate in a linear motion along the vertical direction. The transmission component 330 is configured to transmit the linear motion of the push rod 320 to the mounting column 110, enabling the engraving tool 200 to move in the vertical direction.

In this embodiment, the driving assembly 300 includes an electromagnetic driving component 310, a push rod 320, and a transmission component 330. The electromagnetic driving component 310 is fixed on the mounting body 100, with its output end connected to the push rod 320, enabling the push rod 320 to perform reciprocating linear motion along the vertical direction under the effect of the electromagnetic driving component 310's power supply. The other end of the push rod 320 is connected to the mounting column 110 through the transmission component 330. The two ends of the transmission component 330 are respectively connected to the push rod 320 and the mounting column 110, establishing a stable force transmission relationship between the two. When the equipment operates, and the control system issues a cutting instruction, the electromagnetic driving component 310 is powered on to generate a driving force, driving the push rod 320 to move downward along the vertical direction. The vertical displacement of the push rod 320 is transmitted to the mounting column 110 synchronously through the transmission component 330. The mounting column 110 then drives the entire engraving tool 200 downward, causing the cutter to contact the workpiece surface and complete the engraving or cutting operation. After the cutting action ends, the electromagnetic driving component 310 drives the push rod 320 back to the initial position. The transmission component 330 then pulls the mounting column 110 upward, lifting the engraving tool 200 off the workpiece surface and moving to the next processing path.

This solution allows the cutting action to be directly performed by the electromagnetic driving component 310, with the push rod 320 moving in a straight line along the vertical direction. The single movement direction and short force help control the cutting timing and lifting position during engraving. The transmission component 330 only serves the purpose of motion transmission and connection, forming a relatively independent functional structure between the electromagnetic driving component 310 and the mounting column 110. This design reduces the number of components and assembly complexity, making the cutting mechanism easier to install and maintain. When the engraving tool 200 or the mounting column 110 requires adjustment or replacement, it will not affect the electromagnetic driving component 310 itself, improving the ease of machine maintenance.

The system further includes a protective cover 600 and a flip cover 700, with the flip cover 700 hinged to the protective cover 600. The flip cover 700 and the protective cover 600 together define an accommodating space for the mounting body 100 and engraving tool 200.

The carriage for the engraving tool 1000 also includes the protective cover 600 and flip cover 700. The flip cover 700 is connected to the protective cover 600 via a hinged connection. The protective cover 600 is fixed on the outside of the carriage for the engraving tool 1000, and when the flip cover 700 is in the closed state, it cooperates with the protective cover 600, forming an internal space that accommodates the mounting body 100 and the engraving tool 200. This internal space is in a closed or semi-closed state during the operation of the equipment, providing shielding and protection for the internal structure of the carriage for the engraving tool 1000. During normal engraving operations, the flip cover 700 remains closed, and the engraving tool 200, mounting body 100, and their driving structure are all located within the space defined by the protective cover 600 and flip cover 700. The debris and splashes generated during the cutting, lifting, and reciprocating movement of the cutter are confined within this space, preventing them from spilling outside the equipment, while external dust or foreign objects are also prevented from entering the interior of the carriage for the engraving tool 1000. When tool changes, adjustments, or maintenance operations are needed, the operator can flip open the flip cover 700 around the hinged connection with the protective cover 600, exposing the internal structure of the carriage for the engraving tool 1000, making it easier to directly access the engraving tool 200 and related components. After completing the operation, the flip cover 700 is reset and closed, restoring the protective state without the need to remove the protective cover 600 or other structures.

The present disclosure further provides an engraving machine 800, including the carriage for the engraving tool 1000 mentioned above. The carriage for the engraving tool 1000 is mounted on the engraving machine 800 and is in a sliding connection with the engraving machine 800.

The engraving machine 800 includes a sliding rail 810 and a pulley 820. The sliding rail 810 is mounted on the engraving machine 800, and the sliding rail 810 is connected to the mounting body 100. The pulley 820 is in sliding connection with the sliding rail 810, such that the carriage for the engraving tool 1000 is enabled to reciprocate along the length direction of the engraving machine 800.

In the present disclosure, the engraving machine 800 includes the sliding rail 810 and the pulley 820. The sliding rail 810 is fixedly mounted on an engraving machine body 830 of the engraving machine 800 and serves as a motion guiding structure for the carriage for the engraving tool 1000. The carriage for the engraving tool 1000 is mounted on the engraving machine 800, and the mounting body 100 thereof forms a sliding fit relationship with the sliding rail 810 through the pulley 820, such that the carriage for the engraving tool 1000 is capable of performing linear reciprocating motion along a path defined by the sliding rail 810. During operation of the engraving machine, a control system drives a motion mechanism of the engraving machine 800 according to engraving path requirements, so as to cause the carriage for the engraving tool 1000 to move along the direction of the sliding rail 810. The pulley 820 rolls or slides on the sliding rail 810, thereby guiding the carriage for the engraving tool 1000 to stably move forward or backward along the length direction of the engraving machine 800. In this process, a driving assembly 300 inside the carriage for the engraving tool 1000 is responsible for blade lowering and blade lifting actions, while the sliding rail 810 and the pulley 820 are only configured to provide translational guiding functions.

When the engraving path changes or continuous engraving operations are required, the carriage for the engraving tool 1000 may reciprocate repeatedly within the range of the sliding rail 810 to achieve multi-segment path processing. Since the sliding rail 810 is fixed to the engraving machine body 830 of the engraving machine 800, and the pulley 820 forms a stable connection with the mounting body 100, the carriage for the engraving tool 1000 maintains a consistent relative positional relationship with the engraving machine 800 throughout the entire movement process, thereby ensuring the stability of the engraving trajectory. By providing the sliding rail 810 on the engraving machine 800 and enabling the carriage for the engraving tool 1000 to form a sliding connection with the sliding rail 810 through the pulley 820, shaking and deviation during high-speed operation can be effectively reduced, which is beneficial to improving the accuracy and repeatability of the engraving trajectory. Meanwhile, by designing the carriage for the engraving tool 1000 to be mounted on the engraving machine body 830 of the engraving machine 800 in a sliding manner, rapid installation and disassembly can be achieved through cooperation between the sliding rail 810 and the pulley 820 during equipment assembly, maintenance, or replacement of the carriage for the engraving tool 1000, without requiring large-scale disassembly of the main structure of the engraving machine 800, thereby improving maintenance convenience of the equipment.

The above descriptions are merely preferred embodiments of the present disclosure and are not intended to limit the patent scope of the present disclosure. Any equivalent structure or equivalent process transformation made by using the contents of the specification and drawings of the present disclosure, or directly or indirectly applied to other related technical fields, shall likewise fall within the scope of patent protection of the present disclosure.

What is claimed is:

1. An engraving tool, comprising:
a housing, wherein a terminal piece is disposed in the housing;
a driving motor having one end connected to the terminal piece; and
a cutting tool assembly connected to a driving end of the driving motor;
wherein the terminal piece is configured to connect with an external power supply, and the driving motor is configured to drive the cutting tool assembly to perform telescopic movement in an axial direction.

2. The engraving tool according to claim 1, wherein the driving motor is connected to a sensor configured to detect a rotational speed of the cutting tool assembly.

3. The engraving tool according to claim 1, wherein an output end of the driving motor is connected to a reducer, and an output end of the reducer is connected to the cutting tool assembly for driving the cutting tool assembly to move in the axial direction.

4. The engraving tool according to claim 3, wherein the cutting tool assembly comprises a connecting rod and a cutter head;
wherein one end of the connecting rod is connected to the reducer, and the other end of the connecting rod is connected to the cutter head, so as to drive the cutter head to telescopically move in the axial direction.

5. The engraving tool according to claim 4, wherein the cutting tool assembly further comprises an elastic component disposed between the connecting rod and the housing, wherein the elastic component is configured to apply an axial elastic force to the connecting rod.

6. The engraving tool according to claim 2, wherein an annular groove is disposed in the housing, and the cutting tool assembly is provided with a protruding ring matched with the annular groove, for limiting an axial movement direction of the cutting tool assembly.

7. A carriage for an engraving tool, comprising a mounting body, a driving assembly, and the engraving tool according to claim 1,
wherein the engraving tool is connected to the mounting body through a mounting column, and two ends of the mounting column are respectively connected to the driving assembly and the engraving tool;
wherein a driving end of the driving assembly is connected to the mounting column and is configured to drive the mounting column to reciprocate in a vertical direction, so as to drive the engraving tool to move downwardly or move upwardly in the vertical direction.

8. The carriage for the engraving tool according to claim 7, wherein the mounting body is provided with a cutter-adjusting assembly, one side of the mounting column away from the engraving tool is provided with an adjusting column, and the cutter-adjusting assembly is clamped on the adjusting column.

9. The carriage for the engraving tool according to claim 8, wherein the cutter-adjusting assembly comprises a mounting plate, a first clamping column, and a second clamping column;
wherein the mounting plate is detachably connected to the mounting body, the first clamping column and the second clamping column are both connected to the mounting plate; and
a spacing is formed between the first clamping column and the second clamping column for the adjusting column to pass through.

10. The carriage for the engraving tool according to claim 9, wherein the driving assembly comprises an electromagnetic driving component, a push rod, and a transmission component;
wherein an output end of the electromagnetic driving component is connected to the push rod; and
two ends of the transmission component are respectively connected to the push rod and the mounting column; and
the electromagnetic driving component is configured to drive the push rod to perform reciprocating linear motion in the vertical direction, and the transmission component is configured to transmit linear motion of the push rod to the mounting column, such that the engraving tool moves in the vertical direction.

11. The carriage for the engraving tool according to claim 7, further comprising a protective cover and a flip cover;
wherein the flip cover is hinged to the protective cover, and the flip cover and the protective cover jointly define an accommodating space for accommodating the mounting body and the engraving tool.

12. An engraving machine, comprising the carriage for the engraving tool of claim 7, wherein the carriage for the engraving tool is mounted on the engraving machine and is slidably connected to the engraving machine.

13. The engraving machine according to claim 12, further comprising a sliding rail and a pulley;
wherein the sliding rail is mounted on the engraving machine and is connected to the mounting body; and
the pulley is slidably connected to the sliding rail, such that the carriage for the engraving tool reciprocatingly slides along a length direction of the engraving machine.
